(19) United States
(12) Patent Application Publication
(10) Pub. No.: US 2006/0164479 A1
(43) Pub. Date: Jul. 27, 2006

(54) Liquid container, liquid discharge head including the same, liquid discharge apparatus, method for supplying liquid to liquid discharge head, and liquid discharge method

(75) Inventor: Fumio Takagi, Chino (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/340,193

(22) Filed: Jan. 26, 2006

(30) Foreign Application Priority Data
Jan. 27, 2005 (JP) 2005-019722

(51) Int. Cl. B41J 2/175

(52) U.S. Cl. 347/85

(57) ABSTRACT

A method for supplying a liquid to a liquid discharge head by using a liquid container, the liquid container including: a main body that is attachable to and detachable from the liquid discharge head, that has a liquid receptacle for receiving a liquid to discharge from the liquid discharge head, a supply port for supplying the liquid to the liquid receptacle, and an ejecting port for connecting the liquid receptacle to a flow path provided in the liquid discharge head; a supply-port-sealing member, attachable to and detachable from the main body, capable of hermetically sealing the supply port; and an ejecting-port-sealing member, attachable to and detachable from the main body, capable of hermetically sealing the ejecting port. The liquid supply method includes: opening the supply port, and hermetically sealing the ejecting port with the ejecting-port-sealing member; supplying the liquid through the supply port to the liquid receptacle; hermetically sealing the supply port with the supply-port-sealing member and then opening the ejecting port; attaching the main body to the liquid discharge head; opening the supply port; and aspirating the liquid through a nozzle hole of the liquid discharge head, and filling the nozzle hole to its top end with the liquid.

### CROSS-REFERENCE TO RELATED APPLICATIONS

This application relates to and claims priority from Japanese Patent Application No. 2005-19722, filed on Jan. 27, 2005, the entire disclosure of which is incorporated herein by reference.

### BACKGROUND

1. Technical Field

The present invention relates to: a liquid container that is used by being attached to a liquid discharge head, that contains a liquid to be supplied to the liquid discharge head; the liquid discharge head to which the liquid container is attached; a liquid discharge apparatus; a method for supplying the liquid to the liquid discharge head; and a liquid discharge method.

2. Related Art

So-called “DNA microarrays” made by fixing DNA molecules on a substrate have been used in order to detect whether or not nucleic acid molecules having a specific base sequence exist in sample solutions. One known method for manufacturing microarrays is to discharge a solution containing DNA molecules onto the surface of a substrate, using a liquid discharge apparatus such as an ink-jet discharge apparatus.

The method using the liquid discharge apparatus has the advantage of being able to manufacture high-density microarrays by narrowing the nozzle pitch. Moreover, so-called “protein chips” made by fixing proteins on the surface of a substrate have been being developed in recent years. The liquid discharge apparatus can also discharge a solution containing proteins and, therefore, is highly versatile.

In general, however, in the liquid discharge apparatus, a certain amount of solution tends to remain in a liquid receptacle (so-called “reservoir”) after the discharge of liquid droplets is finished. It is difficult to collect the residual solution or clean the apparatus. The solution that cannot be collected is discarded at the time of cleaning. However, biogenic-related molecules such as DNA or proteins are often expensive or hard to procure. Therefore, it is not desirable to discard even a small amount of the residual solution. Furthermore, if the liquid discharge apparatus cannot be cleaned sufficiently and if another sample solution is used, contamination tends to occur easily and, as a result, reproducible (microarrays) data cannot be obtained in some cases.

As a method for preventing the solution from remaining in the liquid receptacle and improving the usability of the solution, JP-A-2001-337096 suggests a distributive injection apparatus configured in such a way that a cartridge solution reservoir, which is removable from the distributive injection apparatus, contains a solution; and when the cartridge is attached to the distributive injection apparatus, a pin placed on the distributive injection apparatus opens a hole in the solution reservoir, thereby causing the solution to be introduced to the distributive injection apparatus through the pin.

If the apparatus disclosed in JP-A-2001-337096 is used, almost the entire amount of the solution in the cartridge will flow out and be used and only some solution will remain inside the liquid discharge head. If the solution remains only inside the liquid discharge head, the residual solution amount is very small and it is easy to clean the apparatus.

However, in this distributive injection apparatus, a hole is made in the cartridge when it is used. Accordingly, if the full amount of the solution in the cartridge is not used at the one time, it is difficult to preserve the remaining solution. Also, the cartridge itself has to be thrown away after use.

### SUMMARY

An advantage of some aspects of the invention is the provision of a method for supplying a liquid to a liquid discharge head, and a liquid container used for this method, where the liquid supply method and the liquid container can enable the repeated use of a sample solution in a liquid receptacle and preserve the solution without having to discard it when the sample solution remains in the liquid receptacle.

In order to solve the problems described above, according to an aspect of the invention, there is provided a method for supplying a liquid to a liquid discharge head by using a liquid container, the liquid container including: a main body that is attachable to and detachable from the liquid discharge head, that has a liquid receptacle for receiving a liquid to discharge from the liquid discharge head, a supply port for supplying the liquid to the liquid receptacle, and an ejecting port for connecting the liquid receptacle to a flow path provided in the liquid discharge head; a supply-port-sealing member, attachable to and detachable from the main body, capable of hermetically sealing the supply port; and an ejecting-port-sealing member, attachable to and detachable from the main body, capable of hermetically sealing the ejecting port. This liquid supply method includes: opening the supply port, and hermetically sealing the ejecting port with the ejecting-port-sealing member; supplying the liquid through the supply port to the liquid receptacle; hermetically sealing the supply port with the supply-port-sealing member and then opening the ejecting port; attaching the main body to the liquid discharge head; opening the supply port; and aspirating the liquid through a nozzle hole of the liquid discharge head, and filling the nozzle hole to its top end with the liquid.

This configuration enables the supply of the liquid through the supply port to the liquid receptacle in a state where the ejecting port is hermetically sealed and the supply port is opened. When the liquid is held in the liquid receptacle, if the supply port is hermetically sealed, the liquid will not flow out of the ejecting port due to the external atmospheric pressure directed toward the liquid receptacle. Therefore, the liquid in the liquid receptacle stays there even if the ejecting port is opened and turned downward. Accordingly, by hermetically sealing the supply port, opening the ejecting port, and moving the main body, the main body can be attached to the liquid discharge head so that the ejecting port is connected to the flow path leading to a discharge nozzle provided at the liquid discharge head. After the attachment of the main body to the liquid discharge head, the supply port is opened and the liquid is aspirated through the nozzle hole of the liquid discharge head, so that the liquid can be supplied to the top end of the nozzle hole. The aspiration from the nozzle hole can be conducted by closely attaching a suction unit with a gas-permeable film to the nozzle opening of the liquid discharge head.

On the other hand, if the liquid remains in the liquid receptacle after the required discharge is finished, the main body can be removed from the liquid discharge head without letting the liquid flow out of the ejecting port by hermetically sealing the supply port again with the supply-port-sealing member. The removed main body is sealed with the supply-port-sealing member and the ejecting-port-sealing member and thereby can be used as a liquid preservation container without any modification.

The method according to the above-described aspect of the invention can prevent waste of liquid droplets and therefore is particularly appropriate for cases where the liquid to be discharged contains biogenic-related molecules. Examples of biogenic-related molecules include, without limitation, nucleic acids, such as DNA or RNA, and proteins.

It is also preferable to have the liquid receptacle contain a cleaning agent to clean the liquid discharge head. The inside of the liquid discharge head can be cleaned efficiently by supplying the cleaning agent to the liquid discharge head and discharging it from the discharge nozzle.

According to another aspect of the invention, there is provided a liquid container for containing a liquid to be supplied to a liquid discharge heard. This liquid container includes: a main body including a liquid receptacle with a supply port and an ejecting port for the liquid; a supply-port-sealing member, attachable to and detachable from the main body, capable of hermetically sealing the supply port; and an ejecting-port-sealing member, attachable to and detachable from the main body, capable of hermetically sealing the ejecting port; wherein the main body is attached to the liquid discharge head in such a manner that the ejecting port is connected to a flow path provided in the liquid discharge head.

The liquid container having the above-described configuration can be preferably used in the aforementioned method for supplying liquid to the liquid discharge head.

In the liquid container, it is preferable that the main body include an attachment member for attaching the main body to the liquid discharge head. An example of the attachment member is a convex part that engages with a concave part of the liquid discharge head. This configuration can firmly secure the liquid container on the liquid discharge head and the liquid can be discharged in a preferred manner while keeping the liquid container attached to the liquid discharge head.

Moreover, it is preferable that the main body have two or more liquid receptacles, because then multiple kinds of sample solutions can be prepared at the same time and supplied to the liquid discharge head.

If the main body has two or more liquid receptacles, the main body may be preferably configured in such a way that the supply ports of the respective liquid receptacles are located on the same plane of the main body, and the two or more supply ports can be hermetically sealed at the same time by firmly attaching the supply-port-sealing member to that plane. The main body may also be preferably configured in such a way that the ejecting ports of the respective liquid receptacles are located on another plane of the main body, and the two or more ejecting ports can be hermetically sealed at the same time by firmly attaching the ejecting-port-sealing member to that plane. This configuration can efficiently realize liquid supply, movement of the main body, and attachment of the main body to the liquid discharge head even when there are two or more liquid receptacles.

In this case, it is desirable that a sealant be placed on the surface(s) of the supply-port-sealing member and/or the ejecting-port-sealing member that will be firmly attached to the plane(s) of the main body, where the supply ports and/or the ejecting ports are located. As a result, it is possible to enhance hermetic sealability and, more effectively utilize the method for supplying liquid to the liquid discharge head via the atmospheric pressure—using an aspect of the invention.

It is also preferable that the internal surfaces of the ejecting ports be treated to become lyophilic, while the plane where the ejecting ports are located be made lyophobic. As a result, when the main body is attached to the liquid discharge head, liquid leakage can be prevented at the connection between the ejecting ports and the flow path of the liquid discharge head. Also, when the supply ports of the main body are hermetically sealed with the supply-port-sealing member and the main body is then removed from the liquid discharge head, meniscuses can be formed stably in the ejecting ports and liquid leakage can be prevented when moving the main body.

According to further aspects of the invention, a liquid discharge head to which the liquid container according to the aforementioned aspect of the invention is attached, as well as a liquid discharge apparatus including this liquid discharge head are provided. The liquid discharge head and the liquid discharge apparatus are configured so that the liquid container according to the aforementioned aspect of the invention can be freely attached to and detached from them. Moreover, the liquid discharge head and the liquid discharge apparatus can preferably employ the method for supplying liquid to the liquid discharge head according to the aforementioned aspect of the invention.

### BRIEF DESCRIPTION OF THE DRAWINGS

FIG. 1 is a perspective view of a liquid container according to an aspect of the invention.

FIG. 2 illustrates the steps of a method for supplying a liquid to a liquid discharge head according to an aspect of the invention.

FIG. 3 is an example plan view of a liquid delivery plate.

FIG. 4 is an example plan view of another liquid delivery plate.

FIG. 5 illustrates a liquid preservation method using the liquid container according to an aspect of the invention.

### DESCRIPTION OF EXEMPLARY EMBODIMENTS

An embodiment of the invention will be described with reference to the attached drawings.

Liquid Container

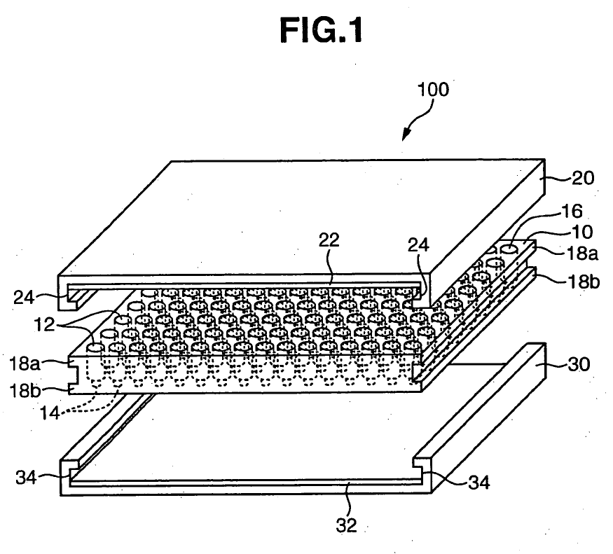

FIG. 1 is a perspective view of a liquid container 100 used in a method for supplying liquid to a liquid discharge head according to an aspect of the invention. The liquid container 100 includes a main body 10, a supply-port-sealing member 20, and an ejecting-port-sealing member 30. In this embodiment, the liquid container 100 is mainly used to supply a solution containing biogenic molecules, such as DNA or proteins, to the liquid discharge head.

The main body 10 has: wells 16 that are liquid receptacles; supply ports 12 for supplying a liquid to the wells 16; and ejecting ports 14 for connecting the wells 16 to flow paths provided in the liquid discharge head. The main body 10 can be stably attached to the liquid discharge head by engaging convex parts 18b (attachment members) on the two opposite side faces of the main body 10, with concave parts of the liquid discharge head described later. In this embodiment, the main body 10 has 128 holes (16×8) for wells 16, but can be configured according to the intended use, for example, as a general-purpose microtiter plate with 96 holes or 384 holes. Referring to FIG. 1, all the supply ports 12 of the wells 16 are located on the top face of the main body 10, while all the ejecting ports 14 of the wells 16 are located on the bottom face of the main body 10.

As shown in FIG. 1, the supply-port-sealing member 20 is to be attached to the top of the main body 10 and can hermetically seal all the supply ports 12 of the wells 16 at the same time. A sealant 22 is placed on the part of the supply-port-sealing member 20 that comes into contact with the top face of the main body 10, in order to enhance hermetical sealability. By engaging convex parts 18a on the two opposite side faces of the main body 10 with concave parts 24 on the supply-port-sealing member 20, the sealant 22 is firmly attached to the supply ports 12, thereby hermetically sealing the supply ports 12.

Moreover, as shown in FIG. 1, the ejecting-port-sealing member 30 is to be attached to the bottom of the main body 10 and can hermetically seal all the ejecting ports 14 of the wells 16 at the same time. A sealant 32 is placed on the part of the ejecting-port-sealing member 30 that comes into contact with the bottom face of the main body 10. By engaging the convex parts 18b, that are also used as the attachment members for attachment to the liquid discharge head, with concave parts 34 of the ejecting-port-sealing member 30, the sealant 32 is firmly attached to the ejecting ports 14, thereby hermetically sealing the ejecting ports 14.

There is no particular limitation on the materials for the supply-port-sealing member 20 and the ejecting-port-sealing member 30. However, if they are made from flexible materials, it will be easier to make the convex parts 18a and 18b engage with the concave parts 24 and 34. Preferred examples of the materials are flexible resins such as polystyrene or polypropylene, which are inexpensive and high productivity. Commercially available packing materials can be used as the sealants 22 and 32.

In this embodiment, the internal surfaces of the ejecting ports 14 are treated to become hydrophilic (or lyophilic) and the surface where the ejecting ports 14 are located, that is, the bottom face of the main body 10 is treated to become hydrophobic (or lyophobic). An example of a method for making the internal surfaces hydrophilic is to coat the internal surfaces with hydrophilic polymers that have high affinity for biogenic molecules. Examples of such polymers include hydroxyethyl methacrylate, N-vinyl pyrrolidone, dimethylacrylamide, glycerol methacrylate, and polyethylene glycol methacrylate. An example of a method for making the bottom face lyophobic (or hydrophobic) is to form a hydrophobic film by evaporating a hydrophobic material, such as fluoroalkyl silane or polyfluoroethylene, by vacuum evaporation. When the liquid is introduced from the ejecting ports 14, the above-described configuration can prevent the liquid from leaking out and running all over the connection parts between the ejecting ports 14 and the flow paths provided in the liquid discharge head.

Method for Supplying Liquid to Liquid Discharge Head

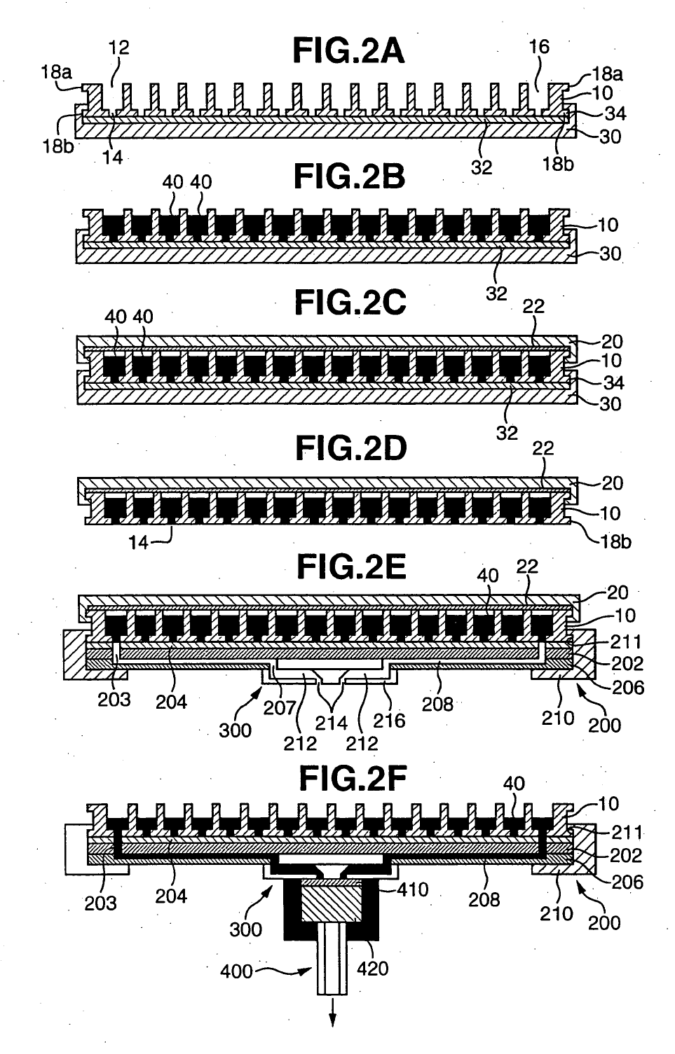

FIG. 2 illustrates a method for supplying a liquid to a liquid discharge head, using the liquid container 100. As shown in FIG. 2A, the ejecting-port-sealing member 30 is attached to the bottom face of the main body 10 to hermetically seal the ejecting ports 14 by engaging the convex parts 18b of the main body 10 with the concave parts 34 of the ejecting-port-sealing member 30.

Next, as shown in FIG. 2B, a liquid 40 is supplied through the supply ports 12 into the wells 16. The liquid 40 can be, for example, a solution containing biogenic-related molecules such as nucleic acids or proteins and be supplied by using a pipet, an automatic distributive injector, or the like. Subsequently, as shown in FIG. 2C, by engaging the convex parts 18a of the main body 10 with the concave parts 24 of the supply-port-sealing member 20, the supply-port-sealing member 20 is attached to the top face of the main body 10, thereby hermetically sealing the supply ports 12. Now, as shown in FIG. 2D, the ejecting-port-sealing member 30 is removed from the main body 10. At this moment, since the supply ports 12 are hermetically sealed with the supply-port-sealing member 20, the liquid 40 is not affected by the external atmospheric pressure through the supply ports 12, and is affected only by the external atmospheric pressure directed through the ejecting ports 14 toward the inside of the wells 16. As a result, even if the ejecting ports 14 face downward, the liquid 40 does not flow out of the ejecting ports 14.

Next, the main body 10 kept in the above-described state is moved to above a liquid discharge head 200, and is then attached to the liquid discharge head 200 as shown in FIG. 2E. The liquid discharge head 200 is part of a liquid discharge apparatus according to an aspect of the invention and is configured in such a way that the main body 10 can be easily attached to and detached from the liquid discharge head 200.

The configuration of the liquid discharge head 200 will be described below. The liquid discharge head 200 is made of a silicon substrate or a glass substrate and includes a nozzle hole 214 for discharging the liquid, and a discharge head chip 300 having a compression chamber 212 or similar. Two liquid delivery plates 202 and 206 are layered above the discharge head chip 300. By layering the two liquid delivery plates 202 and 206, liquid flow paths that connect the ejecting ports 14 of the main body 10 of the mounted liquid container 100 to the nozzle hole 214 are formed. These liquid delivery plates 202 and 206 are fixed to stoppers 210. The main body 10 is attached to the liquid discharge head 200 by engaging concave parts 211 of the stoppers 210 with the convex parts 18b (attachment members) of the main body 10.

It is also preferable that a sealant 204 with through-holes located at positions corresponding to those of the ejecting ports 14 be placed on the liquid delivery plate 202. By placing this sealant 204 so, it is possible to enhance the hermetical sealability and prevent liquid leakage between the liquid delivery plate 202 and the main body 10.

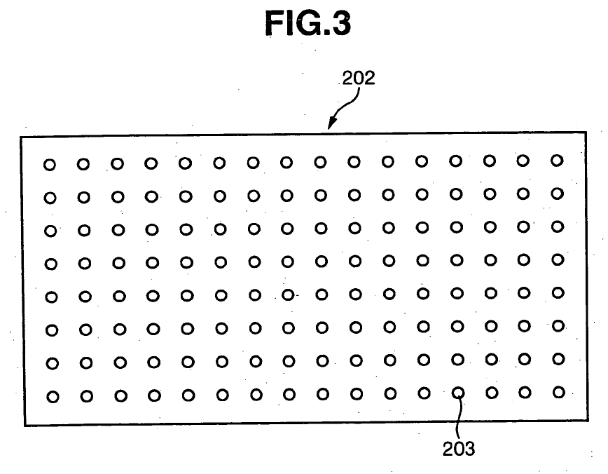

FIG. 3 is a plan view of the liquid delivery plate 202. The liquid delivery plate 202 has the same number of through-holes 203 as the ejecting ports 14; the through-holes 203 are located at positions corresponding to the ejecting ports 14; and the diameter of each through-hole 203 is equal to that of each ejecting port 14. The liquid 40 flowing out of the ejecting ports 14 passes through the through-holes 203 and flows into the flow paths provided in the liquid delivery plate 206.

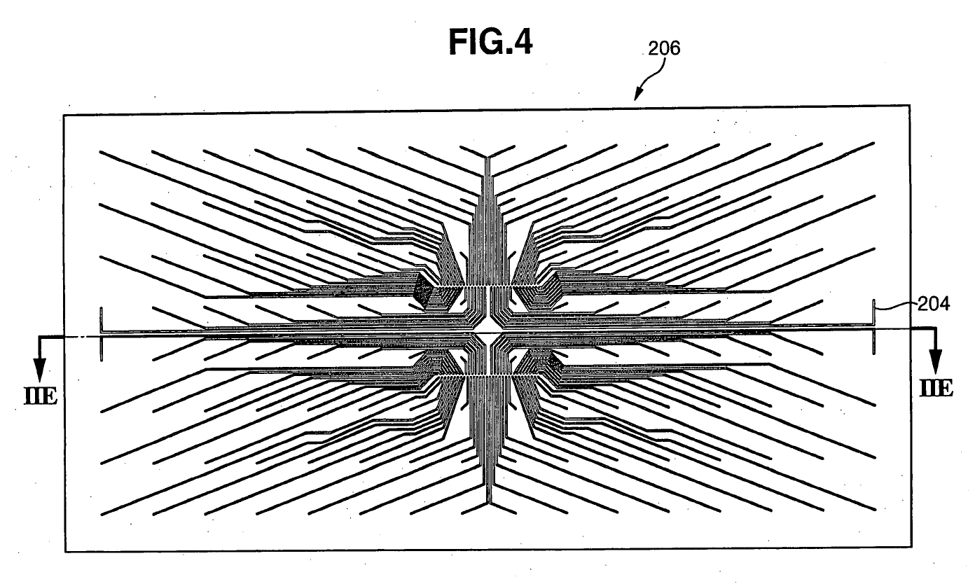

FIG. 4 is a plan view of the liquid delivery plate 206 in which grooves 208, flow paths, are made. The grooves 208 are formed on the surface of the liquid delivery plate 206 and start from the positions corresponding to the through-holes in the liquid delivery plate 202. In this embodiment, the grooves 208 start from 128 start points. The end points of the respective grooves 208 are located above the discharge head chip 300. Holes 207 that pass through the liquid delivery plate 206 are made at the end points, so that the grooves 208 are connected to the compression chamber 212.

As shown in FIG. 2E, while the supply ports 12 are hermetically sealed with the supply-port-sealing member 20, the liquid 40 does not flow out of the ejecting ports 14 and is held in the wells 16.

Subsequently, as shown in FIG. 2F, the supply-port-sealing member 20 is removed from the main body 10 to open the supply ports 12. A suction cap 400 is firmly attached to the bottom face of the discharge head chip 300 where the nozzle hole 214 is open, and aspiration is conducted in the direction indicated with an arrow in FIG. 2F. The aspiration causes the liquid 40 to pass through the through-holes 203 in the liquid delivery plate 202, the grooves 208 in the liquid delivery plate 206, and then the through-holes 207 in the liquid delivery plate 206, be introduced into the compression chamber 212, and then reach the nozzle hole 214. A PTFE membrane 410 with micropores (average pore size: 3 μm) is mounted on the surface of the suction cap 400 and is pressed against the nozzle surface with the restorative force of a sponge 420 in the cap 400. Gas can permeate through this membrane 410, but liquid cannot. Therefore, the liquid 40 which has reached the nozzle hole 214 will not be ejected into the suction cap 400. After the suction cap 400 is moved away from the nozzle surface and the compression chamber 212 is pressurized, the liquid 40 is discharged from the nozzle hole 214. Almost the entire amount of the liquid 40 in the wells 16 can be ejected from the ejecting ports 40 by repeating the above-described discharge process. If the main body 10 is removed and some liquid 40 remains in the wells 16, it will be only in very small amounts, in the through-holes 203 in the liquid delivery plate 202 and the grooves 208 and through-holes 207 in the liquid delivery plate 206, because these holes and grooves are very narrow.

Cleaning

After the liquid 40 in the wells 16 is gone, the main body 10 can be removed from the liquid discharge head 200 and cleaned sufficiently.

On the other hand, the inside of the flow paths in the liquid delivery plates 202 and 206 and the discharge head chip 300 can be cleaned appropriately by the method according to an aspect of the invention described above for supplying liquid to the liquid discharge head, using a cleaning agent as the liquid 40. If a rinse process is necessary after cleaning with the cleaning agent, any preferred solution for the rinse process may be used as the liquid 40 by employing the method for supplying liquid to the liquid discharge head according to the aforementioned aspect of the invention.

Sample Preservation

If the liquid 40 containing a sample remains in the wells 16 after it is supplied to the liquid discharge head and discharged as necessary by using the liquid container 100 according to the aforementioned aspect of the invention, the liquid 40 can be preserved as it is by using the liquid container 100.

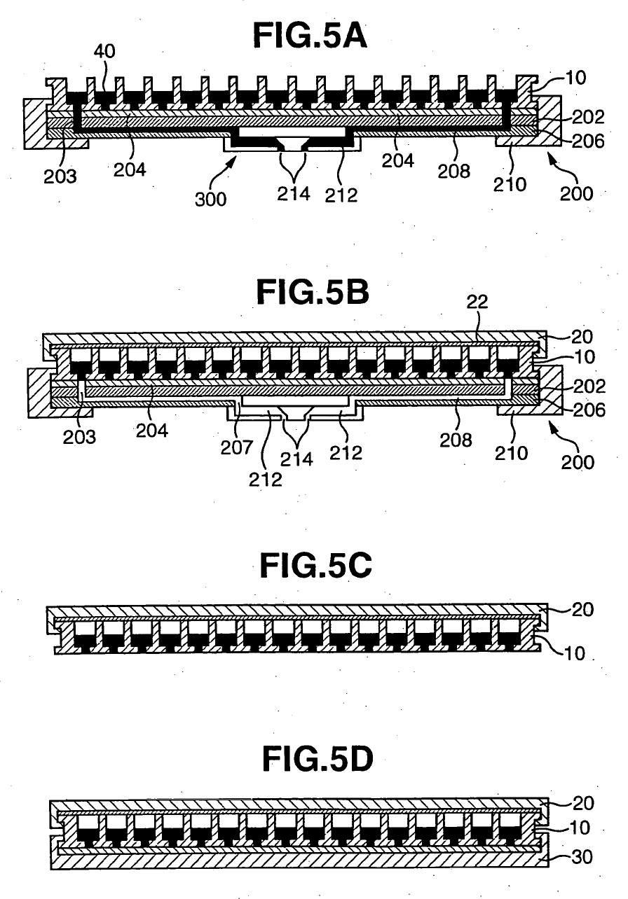

FIG. 5 shows a preservation method. If the liquid 40 remains in the wells 16 as shown in FIG. 5A, firstly the supply-port-sealing member 20 is firmly attached to the main body 10 to hermetically seal the supply ports 12 as shown in FIG. 5B. Then, the main body 10 kept in the above-described state is removed from the liquid discharge head 200 as shown in FIG. 5C, so that the liquid 40 will not flow out of the ejecting ports 14. Subsequently, as shown in FIG. 5D, the ejecting-port-sealing member 30 is attached to the main body 10. As a result, the wells 16 are completely hermetically sealed and the liquid 40 can be preserved by conducting any necessary temperature control or the like depending on the type of the sample.

When it becomes necessary to discharge the liquid 40 later by using the liquid discharge apparatus, the liquid 40 can be supplied to the liquid discharge head by following the steps shown in FIGS. 2C to 2F.

However, the invention is not limited to the embodiment described above, and can be modified or changed in various ways within the scope of the subject matter of the invention. For example, regarding the liquid container described above, the above embodiment describes an example where the convex parts are provided only on the two opposite side faces of the main body. However, the convex parts may be provided on all the four side faces of the main body. Moreover, it is possible to select, for example, the size and materials of the liquid container 100, or the number of the wells 16 according to the intended use as necessary. Also, the liquid 40 is not limited to a solution containing biogenic molecules such as DNA, proteins, or cells, or to a cleaning agent. Any liquid may be used as long as it can be discharged using the liquid discharge apparatus.

1. A method for supplying a liquid to a liquid discharge head by using a liquid container, the liquid container including:
a main body that is attachable to and detachable from the liquid discharge head, that has a liquid receptacle for receiving a liquid to discharge from the liquid discharge head, a supply port for supplying the liquid to the liquid receptacle, and an ejecting port for connecting the liquid receptacle to a flow path provided in the liquid discharge head;
a supply-port-sealing member, attachable to and detachable from the main body, capable of hermetically sealing the supply port; and
an ejecting-port-sealing member, attachable to and detachable from the main body, capable of hermetically sealing the ejecting port;
the liquid supply method comprising:
opening the supply port, and hermetically sealing the ejecting port with the ejecting-port-sealing member;
supplying the liquid through the supply port to the liquid receptacle;
hermetically sealing the supply port with the supply-port-sealing member and then opening the ejecting port;
attaching the main body to the liquid discharge head;
opening the supply port; and
aspirating the liquid through a nozzle hole of the liquid discharge head, and filling the nozzle hole to its top end with the liquid.

2. The method for supplying liquid to the liquid discharge head according to claim 1, wherein the liquid supplied to the liquid discharge head contains biogenic-related molecules.

3. The method for supplying liquid to the liquid discharge head according to claim 1, wherein the liquid supplied to the liquid discharge head is a cleaning agent for the liquid discharge head.

4. A liquid container for containing a liquid to be supplied to a liquid discharge heard, the liquid container comprising:
a main body including a liquid receptacle with a supply port and an ejecting port for the liquid;
a supply-port-sealing member, attachable to and detachable from the main body, capable of hermetically sealing the supply port; and
an ejecting-port-sealing member, attachable to and detachable from the main body, capable of hermetically sealing the ejecting port;
wherein the main body is attached to the liquid discharge head in such a manner that the ejecting port is connected to a flow path provided in the liquid discharge head.

5. The liquid container according to claim 4, wherein the main body includes an attachment member for attaching the main body to the liquid discharge head.

6. The liquid container according to claim 4, wherein the main body has two or more liquid receptacles.

7. The liquid container according to claim 6, wherein the main body has the supply ports for the two or more liquid receptacles on the same plane and the supply-port-sealing member is attached firmly to that plane and thereby capable of hermetically sealing the two or more supply ports at the same time; and the main body also has the ejecting ports for the two or more liquid receptacles on the same plane and the ejecting-port-sealing member is attached firmly to that plane and thereby capable of hermetically sealing the two or more ejecting ports at the same time.

8. The liquid container according to claim 7, wherein the supply-port-sealing member and/or the ejecting-port-sealing member has a sealant on its surface to be firmly attached to the plane of the main body, where the supply ports and/or the ejecting ports are located.

9. The liquid container according to claim 7, wherein the internal surfaces of the ejecting ports are lyophilic, while the plane where the ejecting ports are located is lyophobic.

10. A liquid discharge head with the liquid container according to claim 4 attached thereto.

11. A liquid discharge apparatus comprising the liquid discharge head according to claim 10.
